(19) United States
(12) Patent Application Publication
(10) Pub. No.: US 2010/0008275 A1
(43) Pub. Date: Jan. 14, 2010

(54) NODE SYNCHRONIZATION SYSTEM FOR LOW-POWER IN SENSOR NETWORK AND METHOD THEREOF

(76) Inventors: In-Hwan Lee, Daejon (KR); Chang-Sub Shin, Daejon (KR); Sang-Gi Hong, Daejon (KR); Bong-Soo Kim, Daejon (KR); Cheol-Sig Pyo, Daejon (KR); Jong-Suk Chae, Daejon (KR)

Correspondence Address: STAAS & HALSEY LLP, SUITE 700, 1201 NEW YORK AVENUE, N.W., WASHINGTON, DC, 20005, US

(21) Appl. No.: 12/443,646

(22) PCT Filed: Jun. 1, 2007
(86) PCT No.: PCT/KR2007/002671

§ 371 Date: Mar. 30, 2009

(30) Foreign Application Priority Data
Sep. 29, 2006 (KR) 10-2006-0095562

(51) Int. Cl. G08C 17/00; H04J 3/06

(52) U.S. Cl. 370/311; 370/350

(57) ABSTRACT

Provided are a node synchronization system for low-power in a sensor network and a method thereof. The node synchronization system includes: a network transmitting means for transmitting information on a synchronization time difference to the sensing data collecting means and transmitting sensing data to a network; the sensing data collecting means for receiving synchronization time information from the network transmitting means, being synchronized with the network transmitting means, collecting the sensing data from a sensing means, and transmitting the sensing data to the network transmitting means; and the sensing means for receiving synchronization time information from the sensing data collecting means, being synchronized with the sensing data collecting means, sensing a sensing peripheral environment information, and transmitting the sensing data to the sensing data collecting means.

### TECHNICAL FIELD

The present invention relates to a node synchronization system for low-power in a sensor network and a method thereof; and, more particularly, to a node synchronization system for low-power which can reduce power consumption of nodes by synchronizing nodes of the sensor network, and a method thereof.

### BACKGROUND ART

Conventionally, a desired operation is performed by operating an actuator based on information acquired by a sensor.

At present, according to development of small low-power sensors, a field for applying a technology of connecting low-power sensor nodes through a network has been diversified. Since there are increasing demands for diverse applications using sensors, a research on a controlling and sensing technology through a wireless network has been actively progressed.

In particular, a technology for wirelessly receiving data using a sensor is requested and related research has been progressed. In the ongoing research technology, since a battery is used as a power source due to characteristics of a sink node and a sensor node, the sink node and the sensor node should be turned on continuously or periodically. Accordingly, entire power consumption of the node increases and the battery should be frequently changed. This causes increase of cost and waste of time.

### DISCLOSURE

### Technical Problem

An embodiment of the present invention is directed to providing a node synchronization system for low-power which can reduce power consumption of each node by synchronizing nodes of a sensor network to transmit data, transmitting the data and shifting the data into a sleep mode, and a method thereof.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a node synchronization system for low-power in a sensor network, the system including: a network transmitting means for transmitting information on a synchronization time difference between the network transmitting means and a sensing data collecting means, which is synchronization time information, to the sensing data collecting means and transmitting sensing data from the sensing data collecting means to a network; the sensing data collecting means for receiving information on a synchronization time difference between the sensing data collecting means and the network transmitting means, which is synchronization time information, from the network transmitting means, being synchronized with the network transmitting means, collecting the sensing data from a sensing means, and transmitting the sensing data to the network transmitting means; and the sensing means for receiving information on a synchronization time difference between the sensing means and the sensing data collecting means, which is synchronization time information, from the sensing data collecting means, being synchronized with the sensing data collecting means, sensing a sensing peripheral environment information, and transmitting the sensing data to the sensing data collecting means.

In accordance with another aspect of the present invention, there is provided a node synchronization method for low-power in a sensor network, the method including the steps of: a) preparing for synchronization by receiving a packet notifying start of synchronization; b) receiving a packet which is to be actually synchronized and includes synchronization time information; and c) synchronizing the packet based on the synchronization time information of the packet to be actually synchronized.

In accordance with another aspect of the present invention, there is provided a synchronization method in a gateway of a sensor network, the method including the steps of: a) transmitting a packet notifying start of synchronization to a sink node; b) transmitting a packet which is to be actually synchronized and includes synchronization time information to the sink node; c) checking synchronization with the sink node and starting to transmit/receive data; and d) when data transmission/reception ends, checking whether the gateway is in a sleep mode and being switched into the sleep mode.

In accordance with another aspect of the present invention, there is provided a method for synchronizing sink nodes in a sensor network, the method including the steps of: a) checking synchronization with a gateway; b) transmitting a packet notifying start of synchronization to a sensor node; c) transmitting a packet which is to be actually synchronized and includes synchronization time information to the sensor node; d) checking synchronization with the sensor node and starting data transmission/reception; and e) when data transmission/reception ends, checking whether the sink node is in a sleep mode and being switched into the sleep mode.

In accordance with another aspect of the present invention, there is provided a method for synchronizing sensor nodes in a sensor network, the method including the steps of: a) checking whether sink nodes are synchronized; b) transmitting a packet notifying start of synchronization to sensor nodes that are not synchronized; c) transmitting a packet which is to be actually synchronized and includes synchronization time information to a second sensor node; d) checking synchronization with the second sensor node and starting data transmission/reception; and e) when data transmission/reception ends, checking whether the sensor node is in a sleep mode and being switched into the sleep mode.

In the present invention, the sink node of the sensor network notifies information on a difference between a synchronization signal of the sink node and a synchronization signal of the sensor node, which is synchronization time information, to the sensor node for synchronization of the sensor network. The timer/countering unit of the sensor node compares the synchronization signal difference between the sink node and the sensor node, creates and synchronizes the synchronization signal. When information on difference between the synchronization signal of the synchronized sensor node and the synchronization signal of non-synchronized other sensor node, which is synchronization time information, is notified to the sensor node, the timer/countering unit of the non-synchronized sensor node compares the synchronization signal difference, and creates and synchronizes the synchronization signal. When the synchronization is performed according to Depth based on the method and sensor nodes having a plurality of Depths forms the sensor network, it is possible to economically form the low-power sensor network.

### Advantageous Effects

The present invention can reduce power consumption of each node by synchronizing each node of a sensor network to transmit data, transmitting the data and shifting the data into a sleep mode.

Accordingly, since the present invention can use the sensor node for a long time and a period for changing a battery is extended, it is possible to realize an efficient and economical sensor network.

### BRIEF DESCRIPTION OF THE DRAWINGS

FIG. 1 shows a node synchronization system for low-power in a sensor network in accordance with an embodiment of the present invention.

FIG. 2 is a block diagram showing a node of the sensor network in accordance with the embodiment of the present invention.

FIG. 3 shows a format of the packet data in accordance with an embodiment of the present invention.

FIG. 4 shows an initial timing of each node in the sensor network in accordance with an embodiment of the present invention.

FIG. 5 shows synchronization timing of each node in the sensor network in accordance with an embodiment of the present invention.

FIG. 6 is a flowchart describing a node synchronization method for low-power in the sensor network in accordance with an embodiment of the present invention.

FIG. 7 is a flowchart describing a gateway synchronization procedure in the sensor network in accordance with the embodiment of the present invention.

FIG. 8 is a flowchart describing a sink node synchronization procedure in the sensor network in accordance with the embodiment of the present invention.

FIG. 9 is a flowchart describing a sensor node synchronization procedure in the sensor network in accordance with the embodiment of the present invention.

### BEST MODE FOR THE INVENTION

Other objects and advantages of the present invention will become apparent from the following description of the embodiments with reference to the accompanying drawings. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

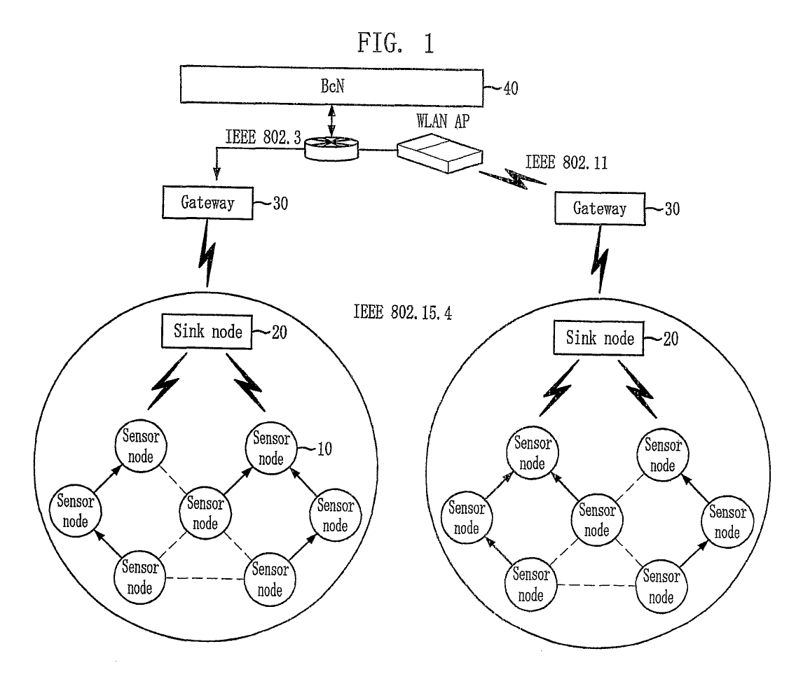

FIG. 1 shows a node synchronization system for low-power in a sensor network in accordance with an embodiment of the present invention.

As shown in FIG. 1, the node synchronization system for low-power according to the present invention includes a sensor node 10, a sink node 20, and a gateway 30.

The sensor node 10 receives information on a synchronization time difference with the sink node 20, i.e., synchronization time information, from the sink node 20, synchronize its time with the time of the sink node 20, senses environment information, e.g., a physical quantity on temperature, rate of flow, air pressure, vibration and motion of an object, and transmits the environment information to the sink node 20.

The sink node 20 receives information on a synchronization time difference with the gateway 30, i.e., synchronization time information, from the gateway 30, synchronizes its time with the time of the gateway 30, collects information sensed by the sensor node 10, and transmits the information to the gateway 30 based on IEEE 802.15.4.

The gateway 30 transmits information on a synchronization time difference with the sink node 20, i.e., synchronization time information, to the sink node 20, receives the collected sensing information from the sink node 20 based on IEEE 802.15.4, and transmits the sensing information to a network 40 such as Broadband Convergence Network (BcN).

Detailed configuration of the sensor network can be differed according to the kind of required services.

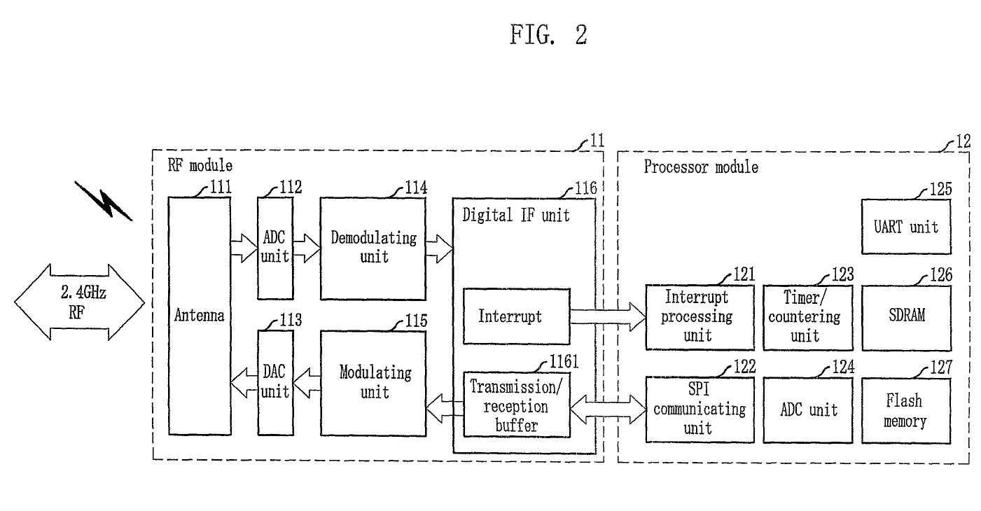

FIG. 2 is a block diagram showing a node of the sensor network in accordance with the embodiment of the present invention.

As shown in FIG. 2, the node of the sensor network used in the present invention, which include the sensor node 10, the sink node 20 and the gateway 30, includes a Radio Frequency (RF) module 11 for supporting RF communication, and a processor module 12, which cooperates with the RF module 11, synchronizes the nodes including the sensor node 10, the sink node 20 and the gateway 30, and processes data.

The RF module 11 includes an antenna 111, an analog-to-digital converting (ADC) unit 112, a digital-to-analog converting (DAC) unit 113, a demodulating unit 114, a modulating unit 115 and a digital intermediate frequency (IF) unit 116.

The antenna 111 transmits/receives a signal. The ADC unit 112 converts an analog signal into a digital signal. The DAC unit 113 converts a digital signal into an analog signal. The demodulating unit 114 demodulates a signal. The modulating unit 115 modulates a signal. The digital IF unit 116 includes a transmission/reception buffer 1161 and transmits an interrupt signal to the processor module 12.

The processor module 12 includes an interrupt processing unit 121, a signal peripheral interface (SPI) communicating unit 122, a timer/countering unit 123, an ADC unit 124, a universal asynchronous receiving/transmitting (UART) unit 125, a synchronous dynamic random memory (SDRAM) 126 and a flash memory 127.

The interrupt processing unit 121 processes an interrupt signal transmitted from the RF module 11. The SPI communicating unit 122 makes it possible to transmit/receive synchronous data to/from the RF module 11 possible. The timer/countering unit 123 compares a synchronization time difference between nodes. The ADC unit 124 converts an analog signal into a digital signal. The UART unit 125 processes serial communication. The SDRAM 126 functions as a memory.

The processor module 12 records a packet for notifying start of synchronization to the transmission/reception buffer 1161 of the RF module 11 through the SPI communicating unit 122 to synchronize each node of the sensor network including the sensor node 10, the sink node 20 and the gateway 30. Subsequently, the processor module 12 transmits the recorded packet to lower nodes and transmits a packet to be actually synchronized.

As an example, the processor module 12 of the sink node 20 loads the synchronization time difference information of the sensor node 10 and the sink node 20 in the packet to be actually synchronized and transmits the synchronization time difference information to the sensor node 10 such that the sensor node 10 receiving the packet can recognize the synchronization difference between the sink node 20 and the processor module 12. Also, the processor module 12 creates a synchronization signal by generating interrupt through the digital IF unit 116 of the sensor node 10 and comparing the synchronization difference with the sink node 20 through the timer/countering unit 123 of the sensor node 10.

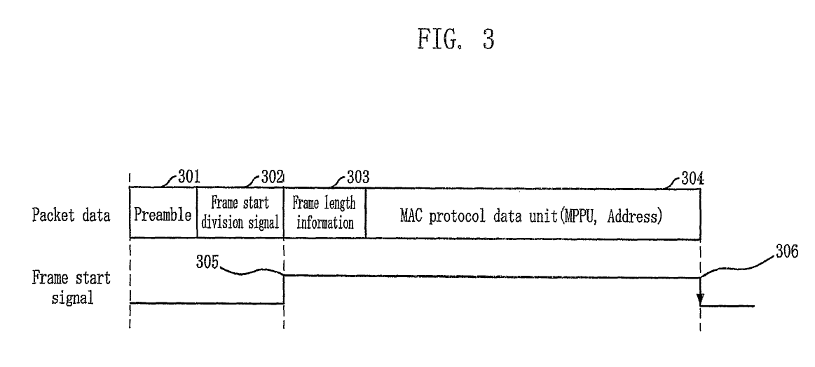

FIG. 3 shows a format of the packet data in accordance with an embodiment of the present invention. As shown in FIG. 3, the packet data used in the present invention includes a preamble 301, a frame starting signal 302, frame length information 303, a Media Access Control (MAC) protocol data unit 304. The preamble 301 notifies start of the packet to be actually synchronized. The frame starting signal 302 notifies a start point of an actual frame. The frame length information 303 is information on the length of the frame. The MAC protocol data unit 304 includes a message protocol data unit (MPDU) and address information.

When generation of the frame starting signal 302 ends, a frame start signal rises (see 305). When the MAC protocol data unit 304 ends, the risen frame start signal falls (see 306).

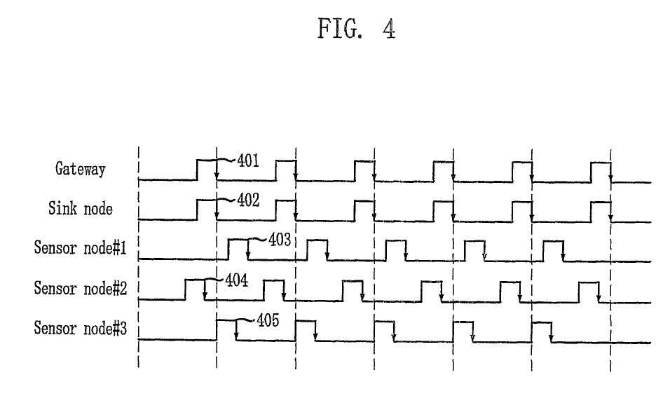

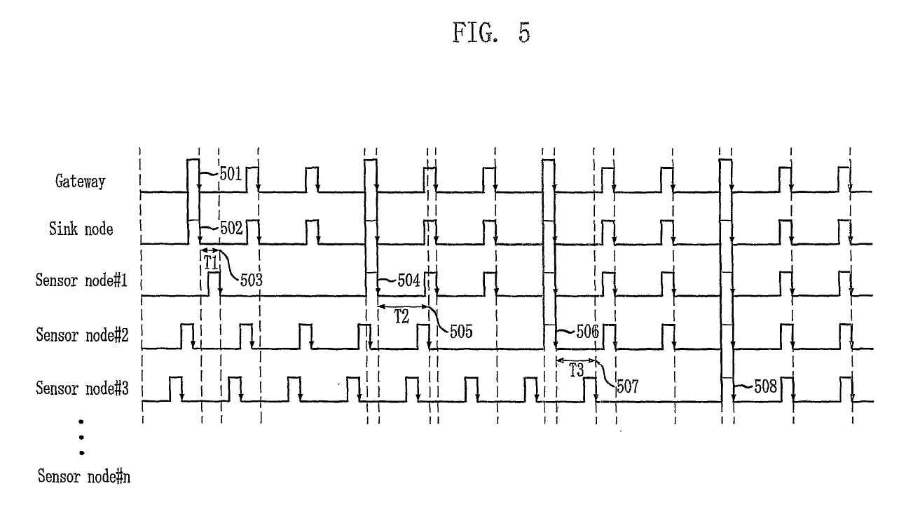

The start signal 305 of the rising frame or the falling frame start signal 306 can be used as a signal for synchronization. In the present invention, a case that the falling frame start signal 306 is used as a signal for synchronization will be described as an example with reference to FIGS. 4 and 5.

FIG. 4 shows an initial timing of each node in the sensor network in accordance with an embodiment of the present invention.

As shown in FIG. 4, since the gateway 30 and the sink node 20 receive a packet notifying the start of the synchronization before the power source of the sensor node 10 turns on, the gateway 30 and the sink node 20 can be synchronized at reference numbers 401 and 402. However, since the sensor node 10 cannot communicate with the sink node 20 when the initial power is turned on, the sensor node 10 cannot be synchronized at reference numbers 403, 404, and 405.

Therefore, the sink node 20 loads information on the synchronization time with the sensor node 10 in a synchronization packet and transmits the information on the synchronization time to the sensor node 10. The sensor node 10 receiving the synchronization packet is synchronized with the sink node 20 based on the information on the synchronization time. The sensor node 10 synchronized with the sink node 20 loads the information on the synchronization time in the synchronization packet and transmits the information on the synchronization time to other sensor node. Other sensor node receiving the synchronization packet synchronizes each node of the sensor network by loading the information on the synchronization time in the synchronization packet and transmitting the information on the synchronization time to other sensor node (see FIG. 5).

FIG. 5 shows synchronization timing of each node in the sensor network in accordance with an embodiment of the present invention.

As shown in reference numbers 501 and 502 of FIG. 5, the sink node 20 synchronized with the gateway 30 transmits a packet notifying start of synchronization to a sensor node#1 in advance. Subsequently, the sink node 20 loads information on a synchronization time difference T1 (see 503) with the sensor node#1, i.e., synchronization time information, in a packet to be actually synchronized and transmit the synchronization time information.

The sensor node#1 prepares for synchronization by receiving a packet notifying the start of packet synchronization from the sink node 20 and is synchronized with the sink node 20 by receiving a packet, which is to be actually synchronized and loaded with information on the synchronization time difference (T1) (see 503), i.e., synchronization time information, and generating a sync signal at a time where the synchronization time difference T1 is subtracted (see 504).

The sensor node#1 synchronized with the sink node 20 transmits a packet notifying the start of synchronization to the sensor node#2 in advance, loads information on the synchronization time difference T2 (see 505) with the sensor node#2, i.e., synchronization time information, in a packet to be actually synchronized and transmits the synchronization time information.

The sensor node#2 prepares for synchronization by receiving a packet notifying the start of packet synchronization from the sensor node#1 10 and is synchronized with the sensor node#1 10 by receiving a packet, which is to be actually synchronized and loaded with information on the synchronization time difference T2 (see 505), i.e., synchronization time information, and generating a sync signal at a time where the synchronization time difference T2 (see 505) is subtracted (see 506).

The sensor node#2 synchronized with the sensor node#1 transmits a packet notifying the start of synchronization to the sensor node#3 in advance, loads information on a synchronization time difference T3 (see 507) with the sensor node#3, i.e., synchronization time information, in a packet to be actually synchronized and transmits the synchronization time information.

The sensor node#3 prepares for synchronization by receiving a packet notifying the start of packet synchronization from the sensor node#2 and is synchronized with the sensor node#2 by receiving a packet, which is to be actually synchronized and loaded with information on the synchronization time difference T3 (see 507), i.e., synchronization time information, and generating a synchronization signal at a time where the synchronization time difference T3 (see 507) is subtracted (see 508).

The nodes of the sensor network including the sensor node 10, the sink node 20 and the gateway 30 can be synchronized in the sensor network by continuously repeating the procedure described above.

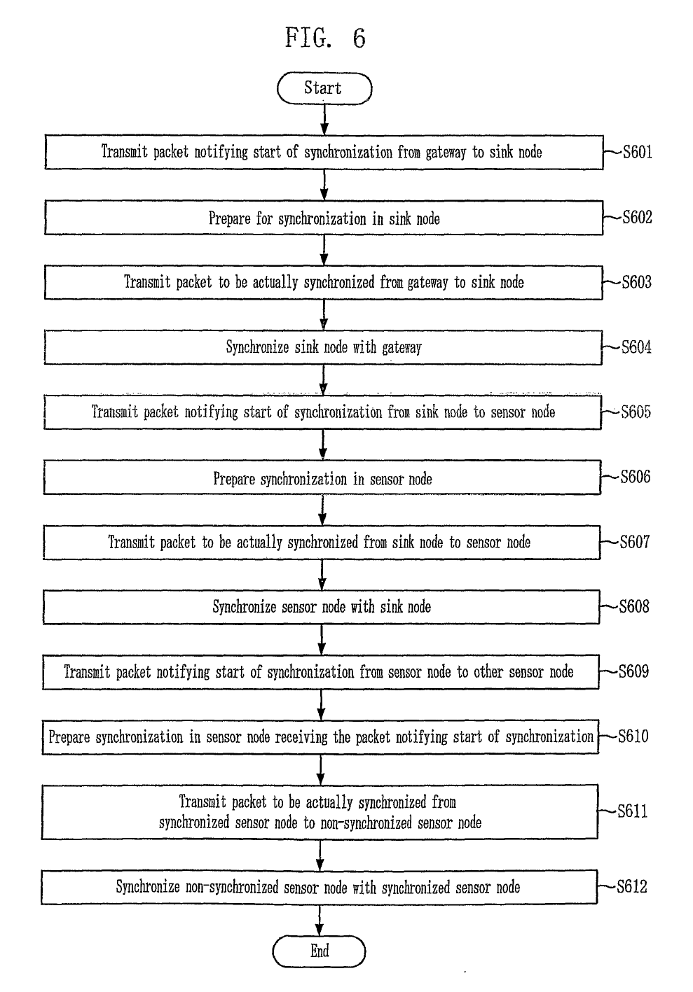

FIG. 6 is a flowchart describing a node synchronization method for low-power in the sensor network in accordance with an embodiment of the present invention.

The gateway 30 transmits a packet notifying start of synchronization to the sink node 20 at step S601 and the sink node 20 prepares for synchronization at step S602 by receiving the packet notifying start of synchronization from the gateway 30.

The gateway 30 transmits a packet to be actually synchronized to the sink node 20 at step S603. The sink node 20 receives the packet to be actually synchronized from the gateway 30 and is synchronized with the gateway 30 based on synchronization time information of the packet to be actually synchronized at step S604.

The sink node 20 synchronized with the gateway 30 transmits the packet notifying start of synchronization to the sensor node 10 at step S605. The sensor node 10 prepares for synchronization by receiving the packet notifying start of synchronization from the sink node 20 at step S606.

The sink node 20 transmits the packet to be actually synchronized to the sensor node 10 at step S607. The sensor node 10 receives the packet to be actually synchronized from the sink node 20 and is synchronized with the sink node 20 based on the synchronization time information of the packet to be actually synchronized at step S608.

The sensor node 10 synchronized with the sink node 20 transmits the packet notifying start of synchronization to other sensor node at step S609. Another sensor node receiving the packet notifying start of synchronization prepares for synchronization at step S610.

The sensor node 10 transmitting the packet notifying start of synchronization transmits the packet to be actually synchronized to the sensor node preparing for synchronization at step S611. The sensor node receiving the packet to be actually synchronized is synchronized with the sensor node 10 transmitting the packet notifying start of synchronization based on the synchronization time information of the packet to be actually synchronized at step S612.

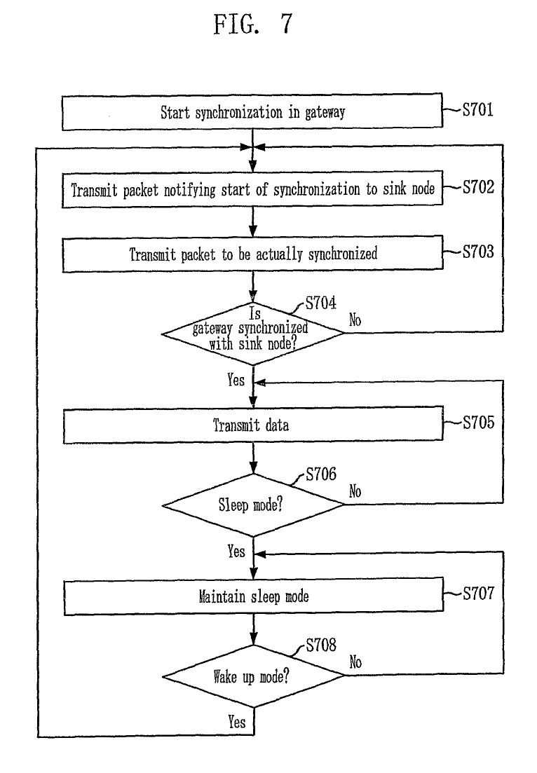

FIG. 7 is a flowchart describing a gateway synchronization procedure in the sensor network in accordance with the embodiment of the present invention.

When synchronization of the gateway 30 starts at step S701, the gateway 30 transmits a packet notifying start of synchronization to the sink node 20 at step S702.

The gateway 30 transmits the packet to be actually synchronized to the sink node 20 at step S703.

The gateway 30 loads time information on a synchronization time difference between the gateway 30 and the sink node 20, i.e., synchronization time information, in the packet to be actually synchronized, and transmits the synchronization time information to the sink node 20.

The gateway 30 determines whether the gateway 30 is synchronized with the sink node 20 at step S704.

When it turns out at step S704 that the gateway 30 is not synchronized with the sink node 20, the gateway 30 performs the step S702. When the gateway 30 is synchronized with the sink node 20, the gateway 30 receives data from the sink node 20 and starts to transmit the data to a network at step S705.

When data transmission ends, it is checked at step S706 whether the gateway 30 is in a sleep mode.

When it turns out at step S706 that the gateway 30 is not in the sleep mode, the gateway 30 performs the step S705. When the gateway 30 is in the sleep mode, the mode of the gateway 30 is converted into the sleep mode and sleeps until the gateway 30 wakes up next time at step S707.

It is checked at step S708 whether the gateway 30 is in a wake-up mode. When it turns out at step S708 that the gateway 30 is not in the wake-up mode, the gateway 30 performs the step S707 and maintains a sleep mode. When the gateway 30 is in the wake-up mode, the gateway 30 performs the step S702 for synchronization of data transmission.

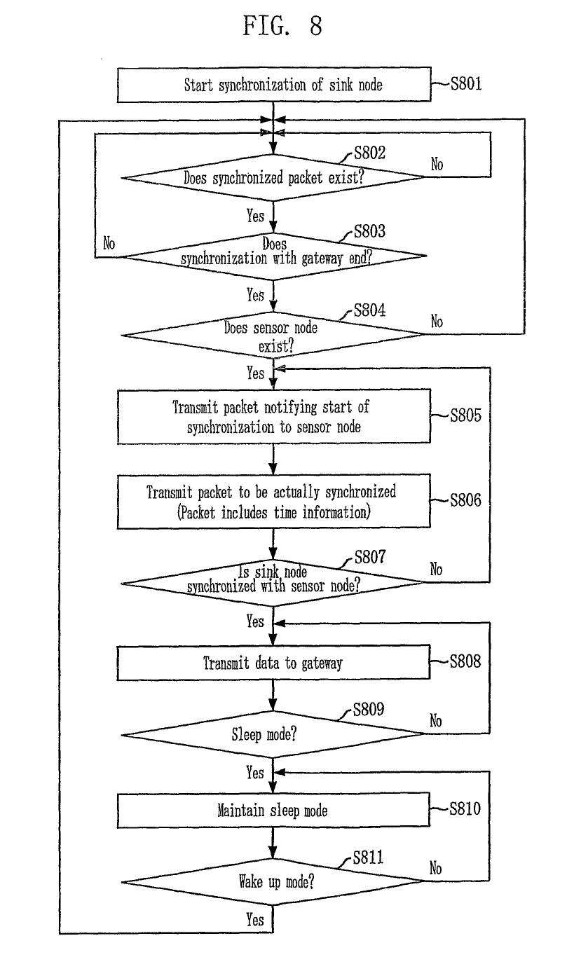

FIG. 8 is a flowchart describing a sink node synchronization procedure in the sensor network in accordance with the embodiment of the present invention.

When synchronization of the sink node 20 starts at step S801, it is checked at step S802 whether a synchronized packet exists to check whether synchronization with the gateway 30 ends.

When it turns out at step S802 that the synchronized packet does not exist, the sink node 20 performs the step S802 again. When the synchronized packet exists, the sink node 20 determines at step S803 whether the synchronization with the gateway 30 ends.

When it turns out at step S803 that the synchronization with the gateway 30 does not end, the sink node 20 performs the step S802 again. When the synchronization with the gateway 30 ends, the sink node 20 checks at step S804 whether the sensor node 10 exists.

When it turns out at step S804 that the sensor node 10 does not exist, the sink node 20 performs the step S802 again. When the sensor node 10 exists, the sink node 20 determines that the synchronization of the sensor node 10 starts and transmits a packet notifying start of synchronization to the sensor node 10 at step S805.

The sink node 20 transmits a packet to be actually synchronized to the sensor node 10 at step S806.

The sink node 20 loads time information on a synchronization time difference between the sink node 20 and the sensor node 10, i.e., synchronization time information, in the packet to be actually synchronized and transmits the synchronization time information to the sensor node 10.

The sink node 20 determines at step S807 whether the sink node 20 is synchronized with the sensor node 10. When the sink node 20 is not synchronized with the sensor node 10, the sink node 20 performs the step S805. When the sink node 20 is synchronized with the sensor node 10, the sink node 20 receives data from the sensor node 10 and starts to transmit the data to the gateway 30 at step S808.

When data transmission of the sensor node 10 ends, it is checked whether the sink node 20 is in a sleep mode at step S809.

When it turns out at step S809 that the sink node 20 is not in a sleep mode, the sink node 20 performs the step S808. When the sink node 20 is in a sleep mode, the mode of the sink node 20 is converted into the sleep mode and sleeps until the mode of the sink node 20 is converted into a next wake-up mode at step S810.

It is checked at step S811 whether the mode of the sink node 20 is converted into the wake-up mode. When the mode of the sink node 20 is not converted into the wake-up mode, the sink node 20 performs the step S810 and maintains the sleep mode. When the mode of the sink node 20 is converted into the wake-up mode, the sink node 20 performs the step S802 for synchronization of data transmission.

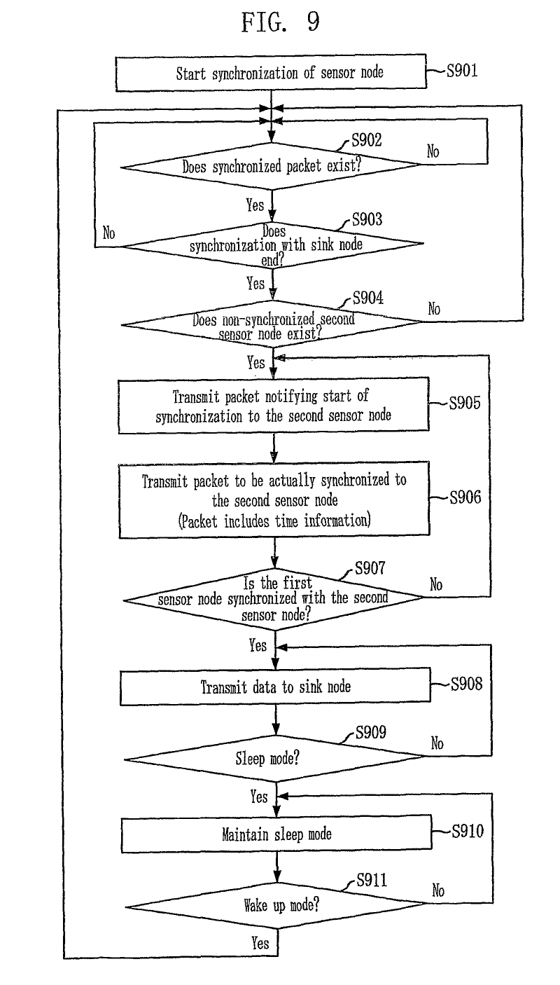

FIG. 9 is a flowchart describing a sensor node synchronization procedure in the sensor network in accordance with the embodiment of the present invention.

When synchronization of the sensor node 10, which is called a first sensor node, starts at step S901, it is checked at step S902 whether a synchronized packet exists to check whether synchronization with the sink node 20 ends.

When it turns out at step S902 that the synchronized packet does not exist, the first sensor node 10 performs the step S902. When the synchronized packet exists, the first sensor node 10 determines at step S903 whether synchronization with the sink node 20 ends.

When it turns out at step S903 that synchronization with the sink node 20 does not end, the first sensor node 10 performs the step S902. When synchronization with the sink node 20 ends, the first sensor node 10 checks at step S904 whether there is a second sensor node that is not synchronized.

When it turns out at step S904 that the second sensor node does not exist, the first sensor node 10 performs the step S902. When the second sensor node exists, the first sensor node 10 determines that synchronization of the second sensor node starts and transmits a packet notifying start of synchronization to the second sensor node at step S905.

The first sensor node 10 transmits a packet to be actually synchronized to the second sensor node at step S906.

The first sensor node 10 loads time information on a synchronization time difference between the first sensor node 10 and the second sensor node, i.e., synchronization time information, in the packet to be actually synchronized and transmits the synchronization time information to the second sensor node.

It is determined at step S907 that the first sensor node 10 is synchronized with the second sensor node. When the first sensor node 10 is not synchronized with the second sensor node, the first sensor node 10 performs the step S905. When the first sensor node 10 is synchronized with the second sensor node, the first sensor node 10 receives data from the second sensor node and starts to transmit the data to the sink node 20 at step S908.

When data transmission ends, it is checked at step S909 whether the first sensor node 10 is in a sleep mode. When it turns out at the step S909 that the first sensor node 10 is not in a sleep mode, the first sensor node 10 performs the step S908. When the first sensor node 10 is in the sleep mode, the first sensor node 10 enters the sleep mode and sleeps until the next wake-up mode comes at step S910.

It is checked at step S911 whether the mode of the first sensor node 10 is switched into the wake-up mode. When the mode of the first sensor node 10 is not switched into the wake-up mode, the first sensor node 10 performs the step S910 and remains in the sleep mode. When the mode of the first sensor node 10 is switched into the wake-up mode, the first sensor node 10 performs the step S902 to synchronize of transmitting data.

As described above, the method of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application No. 2006-0095562, filed in the Korean Intellectual Property Office on Sep. 29, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A node synchronization system for low-power in a sensor network, comprising:
a network transmitting means for transmitting information on a synchronization time difference between the network transmitting means and a sensing data collecting means, which is synchronization time information, to the sensing data collecting means and transmitting sensing data from the sensing data collecting means to a network;
the sensing data collecting means for receiving information on a synchronization time difference between the sensing data collecting means and the network transmitting means, which is the synchronization time information, from the network transmitting means, being synchronized with the network transmitting means, collecting the sensing data from a sensing means, and transmitting the sensing data to the network transmitting means; and
the sensing means for receiving information on a synchronization time difference between the sensing means and the sensing data collecting means, which is the synchronization time information, from the sensing data collecting means, being synchronized with the sensing data collecting means, sensing a sensing peripheral environment information, and transmitting the sensing data to the sensing data collecting means.

2. The node synchronization system of claim 1, wherein the sensing data collecting means is synchronized with the network transmitting means based on the synchronization time information between the sensing data collecting means and the network transmitting means, transmits the sensing data, and goes into a sleep mode.

3. The node synchronization system of claim 2, wherein the sensing means is synchronized with the sensing data collecting means based on synchronization time information between the sensing means and the sensing data collecting means, transmits the sensing data, and goes into the sleep mode in order to transmit the sensing data.

4. The node synchronization system of claim 3, wherein the network transmitting means transmits information on a synchronization time difference between the network transmitting means and the sensing data collecting means, which is synchronization time information, to the sensing data collecting means, is being synchronized with the sensing data collecting means, transmits/receives the sensing data, and goes into the sleep mode again.

5. The node synchronization system of claim 1, wherein the network transmitting means transmits a packet notifying start of synchronization to the sensing data collecting means and transmits a packet including information on a synchronization time difference between the network transmitting means and the sensing data collecting means, which is synchronization time information, to the sensing data collecting means;
the sensing data collecting means transmits a packet notifying start of synchronization to the sensing means and transmits a packet including information on a synchronization time difference between the sensing data collecting means and the sensing means, which is synchronization time information, to the sensing means; and
the sensing means transmits the packet notifying start of synchronization to a second sensing means which is not synchronized and transmits the packet including information on a synchronization time difference between the sensing means and the second sensing means, which is synchronization time information, to the second sensing means.

6. A node synchronization method for low-power in a sensor network, comprising:
preparing for synchronization by receiving a packet notifying start of synchronization;
receiving a packet which is to be actually synchronized and includes synchronization time information; and
synchronizing the packet based on the synchronization time information of the packet to be actually synchronized.

7. A synchronization method in a gateway of a sensor network, comprising:
transmitting a packet notifying start of synchronization to a sink node;
transmitting a packet which is to be actually synchronized and includes synchronization time information to the sink node;
checking synchronization with the sink node and starting to transmit/receive data; and
when data transmission/reception ends, checking whether the gateway is in a sleep mode and being switched into the sleep mode.

8. A method for synchronizing sink nodes in a sensor network, comprising:
checking synchronization with a gateway;
transmitting a packet notifying start of synchronization to a sensor node;
transmitting a packet which is to be actually synchronized and includes synchronization time information to the sensor node;
checking synchronization with the sensor node and starting data transmission/reception; and
when data transmission/reception ends, checking whether the sink node is in a sleep mode and being switched into the sleep mode.

9. A method for synchronizing sensor nodes in a sensor network, comprising:
checking whether sink nodes are synchronized;
transmitting a packet notifying start of synchronization to sensor nodes that are not synchronized;
transmitting a packet which is to be actually synchronized and includes synchronization time information to a second sensor node;
checking synchronization with the second sensor node and starting data transmission/reception; and
when data transmission/reception ends, checking whether the sensor node is in a sleep mode and being switched into the sleep mode.
